(19) United States
(12) Patent Application Publication
(10) Pub. No.: US 2012/0058304 A1
(43) Pub. Date: Mar. 8, 2012

(54) LABEL FILM

(75) Inventors: Joachim Jung, Neunkirchen (DE); Yvonne Duepre, Enkenbach-Alsenborn (DE)

(73) Assignee: TREOFAN GERMANY GMBH & CO. KG, NEUNKIRCHEN (DE)

(21) Appl. No.: 13/263,792

(22) PCT Filed: Apr. 21, 2010
(86) PCT No.: PCT/EP10/21802

§ 371 Date: Nov. 16, 2011

(30) Foreign Application Priority Data
Apr. 24, 2009 (EP) 10 2009 018 543.7
Apr. 30, 2009 (EP) 10 2009 019 323.5

(51) Int. Cl. B32B 3/00

(52) U.S. Cl. 428/141

(57) ABSTRACT

The invention relates to a multilayered, opaque, biaxially oriented polyolefin film having a thickness of at least 30 μm consisting of a vacuole-containing base layer and intermediate layers applied to both sides thereof, and cover layers applied to either side of the intermediate layers. Both intermediate layers have a thickness of at least 3 μm and contain at least 70% by weight of a propylene homopolymer. Both cover layers are constructed from incompatible polymers. The inner cover layer has a surface roughness Rz of at least 3.0 μm and the outer cover layer has a roughness from 1 to 3 μm, the roughness of the inner cover layer being at least 1.5 units greater than the roughness of the outer cover layer.

The present invention relates to a biaxially oriented polypropylene film having surface roughness on both sides, and its use as a label.

Label films comprise an extensive and technically complex field. A distinction is made between various labelling techniques, which are fundamentally different in terms of process conditions and inevitably impose different technical demands on the label materials. A common feature of all labelling processes is that the final result must be visually attractive labelled containers.

In the labelling processes, very different techniques are used to apply the label. Such techniques include self-adhesive labels, wrap-around labels, shrink labels, in-mould labels, patch labelling, etc. The use of a film made of thermoplastic material as a label is possible in all of these various labelling processes.

A common feature of all in-mould labelling processes is that the label is included in the actual moulding process of the container and is applied during the process. Very different moulding processes are used here, such as injection moulding, blow moulding, deep drawing.

In the injection moulding process, individual labels are taken from a stack or cut to size from a roll and inserted into the injection mould. The mould is designed in such a way that the melt stream is injected behind the label and the front of the film rests against the wall of the injection mould. During injection moulding, the hot melt bonds to the label. After injection moulding, the injection mould tool opens, the injection-moulded article together with the label is ejected and cools. As a result, the label has to adhere to the container in wrinkle-free and visually flawless fashion.

Direct in-mould labelling is possible in blow moulding as well. In this method, a molten tube is extruded vertically downwards through a ring-shaped die. A vertically split moulding tool closes and encloses the tube, which is thereby squeezed shut at the bottom end. At the top end, a blow mandrel is inserted, through which the opening of the moulded part is formed. Air is fed into the warm molten tube via the blow mandrel so that it expands and conforms to the inner walls of the moulding tool. In this process, the label has to bond with the viscous plastic material of the molten tube. Afterwards, the mould is opened and the projecting length is cut off at the moulded opening. The moulded and labelled container is ejected and cools down.

In deep drawing, thick, unoriented plastic sheets, mostly cast PP or PS (polystyrene) having a thickness of approximately 200-750 μm are heated and drawn or pressed by means of vacuum or punching tools into an appropriate moulding tool. Here too, the individual label is inserted into the mould and bonds to the actual container during the moulding process. Significantly lower temperatures are used, so that adhesion of the label to the container can be a critical factor.

In principle, films made of thermoplastics may be used for labelling the containers during moulding in all these deep drawing methods. For this purpose, the films must have a selected property profile to ensure that the label film and the moulded body fit against one another smoothly without bubbles and bond to one another. The adhesion of the label to the container is frequently flawed. Furthermore, air inclusions arise between the label and the container, which impair the appearance of the labelled container and also the adhesion. With in-mould labelling, the speed of the process depends to a significant degree on the time that is needed for moulding the container. The corresponding cycle times in which the labels are removed from the stack and manoeuvred are relatively minor in these processes.

The related art includes descriptions of a very wide range of films, which are optimised with regard to their use as in-mould labels. These films often have a rough inner surface, that is to say the surface facing toward the container, to prevent the formation of air inclusions between the container and the label. In contrast, the outer surface is optimised in such manner that the boundary between the applied label and the container is undetectable, which is why the in-mould labels have glossy outer surfaces with low roughness. Such films can still be removed from the stack without difficulty during in-mould labelling. In general, the vacuole-containing base layer us responsible for a small increase in roughness on the glossy side of the label as well, so that a very rough inner cover layer of an incompatible polymer is sufficient to ensure that labels may be removed from the stack easily.

Besides an ability to be removed from the stack reliably, good stiffness of the films is particularly desirable when they are used as labels. Good stiffness also makes the films easier to process during the labelling procedure or while they are being printed beforehand. Particularly during the printing process, the processing speed is directly related to the stiffness of the film. For example, if the cut-to-size film segments are not stiff enough, they are difficult to position in the printing machine with the requisite precision. It is known in the related art to increase the stiffness of opaque films with particularly thick intermediate layers that do not contain any vacuoles. The use of highly isotactic or highly crystalline polypropylenes may also improve stiffness.

In the scope of the present invention, it was found that these measures for increasing stiffness also resulted in reduced roughness of the outer surface of the film, which in turn made processing the film more difficult despite its greater stiffness. Processing is interrupted more often despite the increased stiffness both while the cut-to-size segments are being printed and when the labels are being separated. This problem is not eliminated by an inner cover layer having high surface roughness.

The PCT application PCT/EP 2008/008242 includes a description of multilayered, opaque films for wrap-around labels that are constructed from a vacuole-containing base layer B and intermediate layers applied to both sides thereof as well as cover layers applied to either side of the intermediate layers. The two cover layers contain a mixture of incompatible polymers and have a surface roughness Rz of at least 2.5 μm (0.25 mm cut off). The films also lend themselves very well to destacking in large sheets, and are very well usable as wrap-around labels. These films are associated with the drawback that the print image is impaired by the high surface roughness on the outer side.

It was therefore the object of the present invention to provide a film with improved properties in terms of handling and destacking and by which at the same time the print image is not negatively affected by the high surface roughness on the outer side. The film must be easy to separate during printing and also easy to remove from the stack at high speed during the labelling process.

This object is solved with a multilayered, opaque, biaxially oriented polyolefin film having a thickness of at least 30 μm consisting of a vacuole-containing base layer and intermediate layers applied to both sides thereof, and cover layers applied to either side of the intermediate layers, characterized in that both intermediate layers have a thickness of at least 3 μm and contain at least 70% by weight of a propylene homopolymer, and both cover layers are constructed from a mixture of incompatible polymers, and the inner cover layer has a surface roughness Rz of at least 3.0 μm (cut off 0.25 mm) and the outer cover layer has a roughness Rz from 1 to 3 μm (cut off 0.25 mm), wherein the roughness of the inner cover layer is at least 1.5 units greater than the roughness of the outer cover layer. The subordinate claims describe preferred embodiments of the invention.

In the scope of the present invention, it was discovered that the films satisfy all of the requirements cited in the preceding for the purpose of their use as labels if intermediate layers consisting essentially of propylene homopolymer are applied to both sides and rough cover layers are applied to either side of the intermediate layers, the surface roughness of the two cover layers being created by a mixture of two incompatible polymers and the roughness of the outer surface being in a narrow range from 1 to 3 μm and the roughness of the inner cover layer being greater than the roughness of the outer cover layer.

The process of mixing incompatible polymers, such as propylene copolymers and/or propylene terpolymers with an incompatible polyethylene creates a surface roughness in known manner. Surprisingly, it was found that two rough surfaces of such kind significantly improve the properties of the material in terms of its ability to be removed from a stack and to be separated. It was also very surprising to observe that the homopolymer intermediate layers also contribute to improved stack removal capabilities. It was anticipated that such propylene homopolymer intermediate layers would reduce the surface roughness of the film and thus impair the destacking and separability properties. It is known from the related art that homopolymer intermediate layers are used to improve the surface gloss of opaque films. It was therefore not obvious to incorporate intermediate layers which themselves would improve gloss in a film that was rough on both sides, since the anticipated result of such would be a reduction in roughness and thus also poorer destacking capability. However, it was found, surprisingly, that the destacking capability was improved by the intermediate layers, and that relatively fewer interruptions occur both during printing and when the material is used as a label, if the two surfaces have the roughness indicated respectively for each.

It is therefore essential for the purposes of the present invention that several structural features be satisfied. The film must have a cover layer consisting of incompatible polymers on each side, the roughness Rz of the outer cover layer must be in a range from 1-3 μm, the inner cover layer must have a greater roughness, at least 3 μm, and the film must have intermediate layers of polypropylene on both sides. It is only possible to process the film in the form of large sheets and destack it quickly and reliably when it is used for labels, with an appealing appearance on the outside after printing, if all of these structural features are satisfied.

The film thus comprises at least five layers, the base layer being the central, inner layer and having the greatest thickness of all the layers. The intermediate layers are applied between the base layer and the cover layers, in general directly on the respective surfaces of the base layer. By their nature, cover layers form the outer layers of the film, and in five-layered embodiments are disposed directly on the intermediate layers. The film may also include additional layers provided such does not inhibit the desired properties of the film.

Both cover layers contain propylene homopolymer, copolymer and/or terpolymer of propylene, ethylene and/or butylene units and polyethylene as components that are essential for the purposes of the invention.

In general, the inner cover layers contain at least 30 to 90% by weight, preferably 45 to 80% by weight, particularly 50 to 80% by weight of the propylene homopolymer, copolymer and/or terpolymer, and 10 to 70% by weight, preferably 20 to 55% by weight, particularly 20 to 50% by weight of the polyethylene relative to the weight of the respective cover layer, and additional usual additives as required in the effective quantities for each. The relative content of the polymers is slightly reduced in proportion with the addition of such additives. For the purposes of the present invention, the inner cover layer is the layer whose surface is facing towards the container to which a label has been applied when the film is used as the label.

In general, the outer cover layers contain at least 65 to 98% by weight, preferably 70 to 97% by weight, particularly 75 to 95% by weight of the propylene homopolymer, copolymer and/or terpolymer, and 2 to 35% by weight, preferably 3 to 30% by weight, particularly 5 to 25% by weight of the polyethylene, relative to the weight of the respective cover layer, and additional usual additives as required in the effective quantities for each. The relative content of the polymers is slightly reduced in proportion with the addition of such additives. For the purposes of the present invention, the outer cover layer is the layer whose surface is facing outwards and visible when the film is used as the label.

Suitable propylene polymers and ethylene polymers for both cover layers will be described in greater detail in the following. The same polymers may be used in the quantities indicated in the preceding for both cover layers. Different polymers may also be selected for use in the inner and outer cover layers.

Co- or terpolymers that are suitable for the cover layers are constructed from ethylene, propylene, or butylene units, in which case terpolymers contain three different monomers. The composition of the copolymers or terpolymers from the respective monomers may vary within the limits described in the following. In general, the co- and/or terpolymers contain over 50% by weight propylene units, that is to say they are propylene copolymers and/or propylene terpolymers with ethylene and/or butylene units as comonomers. Copolymers generally contain at least 60-99% by weight, preferably 65 to 97% by weight propylene and not more than 1-40% by weight, preferably 3 to 35% by weight ethylene or butylene as the comonomer. Terpolymers generally contain 65 to 96% by weight, preferably 72 to 93% by weight propylene, and 3 to 34% by weight, preferably 5 to 26% by weight ethylene and 1 to 10% by weight, preferably 2 to 8% by weight butylene. The melt index of the co- and/or terpolymers is generally 0.1 to 20 g/10 min (190° C., 21.6N), preferably 0.1 to 15 g/10 min. The melting point may be in a range from 70 to 150° C., preferably from 100 to 140° C.

If desired, the co- and terpolymers cited in the preceding may be mixed with each other. In this case, the relative proportions of copolymer to terpolymer may be varied at will. This mixture may then be used in the quantities described for the respective copolymers and terpolymers in any cover layer.

In a further embodiment, propylene homopolymer may also be used instead of or in addition to the named co- and/or terpolymer. The surface pretreatment in this variant may not be as durable, however, so this embodiment is possible but not preferred. The homopolymers are used in the quantities described for the co- and terpolymers. Suitable propylene homopolymers are those described individually in the following as propylene homopolymers of the base layer. If desired, the homopolymers may also be mixed with the co- and/or terpolymer. The proportion of co- and/or terpolymer is then reduced by an amount corresponding to the proportion of homopolymer.

It is essential for the purposes of the invention that the proportions and type of co- and/or terpolymers, homopolymer if applicable, and polyethylene for the inner cover layer are selected in such manner that the surface roughness Rz of the inner cover layer is at least 3 μm, preferably 3 to 8 μm. If applicable, additional measures such as surface treatment and layer thicknesses and pigmentation of the intermediate layer, for example with white pigment such as TiO₂ and the addition of antiblocking agents must be selected so as to ensure that this Rz value is achieved. It is also essential for the purposes of the invention that the proportions and type of co- and/or terpolymers, homopolymer if applicable, and polyethylene for the outer cover layer are selected in such manner that the surface roughness Rz of the outer cover layer is at least 1 to 3 μm, preferably 1.5 to 2.5 μm. For the roughness of the outer cover layer also, additional measures such as surface treatment and layer thicknesses and pigmentation of the intermediate layer, for example with white pigment such as TiO₂ and the addition of antiblocking agents must be selected so as to ensure that this Rz value is achieved.

In general, both cover layers are essentially free from particulate filler materials, that is to say the quantity of such is generally less than 5% by weight, preferably less than 2% by weight, in order to avoid negative effects such as chalking, in addition to which the print image is impaired by filler materials. This recommendation does not contradict the additional incorporation of antiblocking agents, which are generally used in quantities below 2% by weight.

The second component of the two cover layers that is essential for the purposes of the invention is a polyethylene that is incompatible with the co- and/or terpolymers, propylene homopolymers if applicable, as described above. In this context, incompatible means that a surface roughness is formed when the propylene homopolymers, co- and/or terpolymers are mixed with the polyethylene. It is assumed that this roughness is caused by the two separate phases that form the immiscible polymers. Examples of suitable polyethylenes are HDPE or MDPE. HDPE in general has the properties described in the following, for example an MFI (50 N/190° C.) of greater than 0.1 to 50 g/10 min, preferably 0.6 to 20 g/10 min, measured according to DIN 53 735 and a viscosity number, measured in accordance with DIN 53 728 part 4 or ISO 1191, in the range from 100 to 450 cm³/g, preferably 120 to 280 cm³/g. Its crystallinity is generally 35 to 80%, preferably 50 to 80%. Its density, measured at 23° C. in accordance with DIN 53 479 procedure A or ISO 1183, is in the range from >0.94 to 0.96 g/cm³. The melting point, measured by DSC (maximum of the melt curve, heating rate 20° C./min), is between 120 and 140° C. Suitable MDPE generally has an MFI (50 N/190° C.) greater than 0.1 to 50 g/10 min, preferably 0.6 to 20 g/10 min, measured in accordance with DIN 53 735. The density, measured at 23° C. in accordance with DIN 53 479 method A or ISO 1183, is in the range from >0.925 to 0.94 g/cm³. The melting point, measured by DSC (maximum of the melt curve, heating rate 20° C./min), is between 115 and 130° C.

The cover layer may contain small quantities of additional olefinic polymers if necessary, providing this does not impair its functionality, particularly the surface roughness essential to the invention. In this context, polymers that are incorporated in the respective cover layer via additive batches are conceivable, for example.

For the cover layers, propylene-ethylene copolymers in a mixture with MDPE or HDPE are preferred. The ethylene content of the copolymers is preferably 2 to 10% by weight and the melting point is in a range from 120-135° C. The surface of the outer cover layer particularly advantageously undergoes a corona treatment.

The layer thickness of the inner cover layer is generally 2 to 10 μm, preferably 2.5 to 8 μm, particularly 3 to 6 μm. A cover layer having greater thickness, of at least 2.5 μm is advantageous in increasing roughness. The layer thickness of the outer cover layer is generally 0.5 to 5 μm, preferably 1 to 3 μm. A thinner cover layer thickness enables the roughness Rz to be adjusted in the range of the invention from 1 to 3 μm.

The surface roughnesses Rz of the two cover layers differ by at least 1.5 μm, the inner cover layer having greater roughness than the outer cover layer. In general, the difference is in the order of 1.8 to 8 μm, preferably 2 to 5 μm.

It was discovered within the scope of the present invention that the surface roughness of the outer cover layer must lie within a narrow range from 1-3 μm and the roughness of the inner cover layer must be significantly greater in order for the film to satisfy all requirements imposed by its use as a label film.

In a particularly preferred embodiment, one or both surfaces are undergo corona, plasma or flame treatment. This treatment improves the adhesive properties of the outer surface for subsequent decoration and printing, that is to say for ensuring the coverage and adhesion of printing inks and other decorative means. If required, the surface of the outer cover layer may also be metallised.

Each of the two cover layers may also contain usual additives such as neutralising agents, stabilisers, antistatic agents, antiblocking agents and/or lubricants in effective quantities in each case. The following figures in percent by weight refer to the weight of the respective cover layer.

Suitable antiblocking agents are inorganic additives such as silicon dioxide, calcium carbonate, magnesium silicate, aluminium silicate, calcium phosphate and similar and/or incompatible organic polymerisates such as polyamides, polyesters, polycarbonates and similar or crosslinked polymers such as crosslinked polymethyl methacrylate or crosslinked silicone oils. The average particle size is between 1 and 6 μm, particularly between 2 and 5 μm. The effective quantity of antiblocking agent is in the range from 0.1 to 2% by weight, preferably 0.5 to 1.5% by weight.

Lubricants are higher aliphatic acid amides, higher aliphatic acid esters and metal soaps such as polydimethylsiloxanes. The effective quantity of lubricant is in the range from 0.01 to 3% by weight, preferably 0.02 to 1% by weight relative to the inner cover layer. The addition of 0.02 to 0.5% by weight polydimethylsiloxanes, particularly polydimethylsiloxanes having a viscosity of 5000 to 1,000,000 mm2/s is particularly suitable.

According to the invention, the film has additional intermediate layers between the opaque base layer and the two rough cover layers on both sides. For the purposes of the present invention, the term “opaque film” means a non-transparent film with a translucency (ASTM-D 1003-77) not more than 70%, preferably not more than 50%.

The opaque base layer of the film contains at least 70% by weight, preferably 75 to 99% by weight, particularly 80 to 98% by weight polyolefins or propylene polymers, preferably propylene homopolymers and vacuole-initiating filler substances, relative to the weight of the base layer in each case.

In general, the propylene polymer contains at least 90% by weight, preferably 94 to 100% by weight, particularly 98 to <100% by weight propylene. The corresponding comonomer content of not more than 10% by weight or 0 to 6% by weight or 0 to 2% by weight is generally constituted by ethylene, if it is present. The weight percent values indicated are relative to the propylene polymer in each case.

Isotactic propylene homopolymers having a melting point from 140 to 170° C., preferably from 150 to 165° C., and a melt flow index (measurement according to DIN 53 735 under 21.6 N load and at 230° C.) from 1.0 to 10 g/10 min, preferably from 1.5 to 6.5 g/10 min, are preferred. The n-heptane soluble fraction is generally 0.5 to 10% by weight, preferably 2 to 5% by weight relative to the starter polymer. The molecular weight distribution of the propylene polymer may vary. The ratio of the weight average Mw to the number average Mn is generally between 1 and 15, preferably between 2 and 10, particularly preferably between 2 and 6. A molecular weight distribution of this narrow order may be achieved for the propylene homopolymer of the base layer for example by peroxide reduction thereof or by manufacturing the polypropylene with the aid of suitable metallocene catalysts. For the purposes of the present invention, suitable polypropylenes are highly isotactic and/or highly crystalline, with an isotacticity of at least 95%, preferably 96-99% measured according to ¹³C-NMR. Such highly isotactic polypropylenes are known in the related art and are designated both as HIPP and HCPP.

The opaque base layer contains vacuole-initiating fillers in a quantity not exceeding 30% by weight, preferably 1 to 15% by weight, particularly 2 to 10% by weight relative to the weight of the base layer. Besides the vacuole-initiating fillers, the base layer may also contain pigments, for example in a quantity from 0.5 to 10% by weight, preferably 1 to 8% by weight, particularly 1 to 5% by weight. These percentages are relative to the weight of the base layer.

For the purposes of the present invention, pigments are incompatible particles that do not contribute significantly to vacuole formation when the film is stretched. The colouring effect of the pigments is caused by the particles themselves. “Pigments” generally have an average particle diameter of 0.01 to a maximum of 1 μm, preferably 0.01 to 0.7 μm, particularly 0.01 to 0.4 μm. Pigments include both “white pigments”, which colour the films white, and “colour pigments” which lend the films a coloured or black appearance. Usual pigments are materials such as aluminium oxide, aluminium sulphate, barium sulphate, calcium carbonate, magnesium carbonate, silicates such as aluminium silicate (kaolin clay) and magnesium silicate (talcum), silicon dioxide and titanium dioxide, of which white pigments such as calcium carbonate, silicon dioxide, titanium dioxide and barium sulphate are preferred.

In general, at least 95% by weight of the titanium dioxide particles is rutile and is preferably used with a coating of inorganic oxides and/or of organic compounds having polar and nonpolar groups. Such coatings for TiO2 are known in the prior art.

For the purpose of the present invention, “vacuole-initiating fillers” are understood to be solid particles that are incompatible with the polymer matrix and cause the formation of vacuole-like cavities when the films are stretched, the size, nature and number of vacuoles depending on the size and quantity of the solid particles and the stretching conditions such as stretch ratio and stretch temperature. The vacuoles lower the density and lend the films a characteristic, nacreous, opaque appearance, which is caused by light scattering at the “vacuole/polymer matrix” boundary surfaces. The light scattering on the solid particles themselves generally contributes relatively little to the opacity of the film. As a rule, the vacuole-initiating fillers have a minimum size of 1 μm in order to create an effective, that is to say opacity inducing quantity of vacuoles. The average particle diameter of the particles is generally 1 to 6 μm, preferably 1.5 to 5 μm. The chemical character of the particles is less important providing incompatibility exists.

Usual vacuole-initiating fillers are inorganic and/or organic materials that are incompatible with propylene, and these include aluminium oxide, aluminium sulphate, barium sulphate, calcium carbonate, magnesium carbonate, silicates such as aluminium silicate (kaolin clay) and magnesium silicate (talcum) and silicon dioxide, of which calcium carbonate and silicon dioxide are preferred. With regard to organic fillers, the polymers that are normally used due to their incompatibility with the polymer of the base layer may be considered, particularly including HDPE, copolymers of cyclic olefins such as norbornene or tetracyclododecene with ethylene or propylene, polyesters, polystyrenes, polyamides, halogenated organic polymers, polyesters such as polybutylene terephthalate being preferred. For the purpose of the present invention, “incompatible materials or incompatible polymers” is understood to mean that the material or polymer in question is present in the film as a separate particle or a separate phase.

The density of the film may vary within a range of 0.5 to 0.85 g/cm³ depending on the composition of the base layer. The vacuoles help to lower the density, whereas the pigments, such as TiO2, tend to increase the density of the film due to their higher specific weight. The density of the film is preferably 0.6 to 0.8 g/cm³ due to the vacuole-containing base layer.

The base layer may also contain the usual additives such as neutralising agents, stabilisers, antistatic agents and/or lubricants in their respective effective quantities. The percentages by weight cited in the following are relative to the weight of the base layer in each case.

Preferred antistatic agents are glycerol monostearates, alkaline alkane sulphonates, polyether-modified, that is to say ethoxylated and/or propoxylated polydiorganosiloxanes (polydialkylsiloxanes, polyalkylphenyl siloxanes and similar) and/or the essentially unbranched and saturated aliphatic tertiary amines with an aliphatic radical having 10 to 20 carbon atoms substituted with alphahydroxy (C1-C4) alkyl groups, wherein N,N-bis-(2-hydroxyethyl)alkyl amines having 10 to 20 carbon atoms, preferably 12 to 18 carbon atoms in the alkyl radical are particularly suitable. The effective quantity of antistatic agent is in the range from 0.05 to 0.5% by weight.

Lubricants are higher aliphatic acid amides, higher aliphatic acid esters, waxes and metal soaps such as polydimethylsiloxanes. The effective quantity of lubricant is in the range from 0.01 to 3% by weight, preferably 0.02 to 1% by weight. The addition of aliphatic acid amides in a quantity in the range from 0.01 to 0.25% by weight of the base layer is particularly suitable. Particularly suitable aliphatic acid amides are erucic acid amide and stearyl amide.

The compounds that are normally used to stabilise ethylene polymers, propylene polymers and other olefinic polymers may be used as stabilising agents, as in the other layers also. These are added in a quantity between 0.05 and 2% by weight. Phenolic and phosphitic stabilisers such as tris-2,6-dimethylphenyl phosphite are particularly suitable. Phenolic stabilisers having a molar mass greater than 500 g/mol are preferred, particularly pentaerythrityl-tetrakis-3-(3,5-di-tert.butyl-4-hydroxyphenyl)propionate or 1,3,5-trimethyl-2,4,6-tris(3,5-di-tert.butyl-4-hydroxy-benzyl)benzene. In this context, phenolic stabilisers are used alone in a quantity of 0.1 to 0.6% by weight, particularly 0.1 to 0.3% by weight, and phenolic and phosphitic stabilisers are used in a ratio from 1:4 to 2:1 and in a total quantity of 0.1 to 0.4% by weight, particularly 0.1 to 0.25% by weight.

Neutralising agents, as are also used in the other layers, are preferably dihydrotalcite, calcium stearate and/or calcium carbonate having an average particle size not greater than 0.7 μm, an absolute particle size smaller than 10 μm and a specific surface area of at least 40 m²/g. In general, 0.02 to 0.1% by weight neutralising agent is added.

The intermediate layers contain 70 to 100% by weight, preferably 80 to 99% by weight propylene homopolymer. Preferred are isotactic propylene homopolymers, which may contain up to 2% by weight ethylene as the comonomer (Minicopo) having a melting point from 140 to 170° C., preferably from 150 to 165° C., and a melt flow index (measurement according to DIN 53 735 under 21.6 N load and at 230° C.) from 1.0 to 10 g/10 min, preferably from 1.5 to 6.5 g/10 min, are preferred. The n-heptane soluble fraction of the polymer is generally 0.5 to 10% by weight, preferably 2 to 5% by weight relative to the starter polymer. The molecular weight distribution of the propylene polymer may vary. The ratio of the weight average Mw to the number average Mn is generally between 1 and 15, preferably between 2 and 10, particularly preferably between 2 and 6. A molecular weight distribution of this narrow order may be achieved for the propylene homopolymer of the intermediate layer for example by peroxide reduction thereof or by preparing the polypropylene with the aid of suitable metallocene catalysts.

Highly isotactic and/or highly crystalline polypropylenes, with an isotacticity of at least 95%, preferably 96-99%, measured according to ¹³C-NMR, are preferably used in the intermediate layers. This embodiment is noteworthy for the high levels of stiffness it produces. It was discovered that intermediate layers made from highly isotactic propylene polymers also cover the vacuole-containing base layer in such manner that the base layer no longer has any effect on surface roughness. The thicker the intermediate layers are, the more pronounced this effect is. At the same time, however, the improvement in stiffness also becomes more pronounced as the intermediate layers become thicker. Thus at the same time the improvement in stiffness due to thick intermediate layers of highly isotactic propylene polymers also has a negative effect on the destacking capability and separability of the film when it is used as a label. Surprisingly, this negative effect does not occur if the roughness of the outer surface is also increased to 1-3 μm by adding an incompatible polyethylene. The invention thus has particularly advantageous effects in embodiments with intermediate layers that contain highly isotactic propylene polymers.

The intermediate layers may contain the usual additives described for the individual layers, such as antistatic agents, neutralising agents, lubricants and/or stabilisers. The thickness of the intermediate layers is generally at least 3 μm and is preferably in the range from 4-12 μm, particularly 6 to 10 μm in each case.

For embodiments in which it is desirable for the label to appear white with high opacity, one, and if desired both, intermediate layer(s) may optionally include pigments, particularly TiO2, for example in a quantity of 2 to 8% by weight relative to the weight of the intermediate layer. In general, however, the intermediate layers do not contain any vacuoles and thus have a density of ≧0.9 g/cm³.

The overall thickness of the label film is at least 30 μm and is preferably in a range from 35 to 90 μm, particularly from 45 to 75 μm. For the purposes of the present invention, the inner cover layer is the cover layer that faces towards the container during and after the labelling process. Accordingly, the outer cover layer is located on the opposite side.

Surprisingly, the film according to the invention may be processed at high cycle rates without malfunctions.

For example, the film may be separated and printed in accordance with the invention at a speed of up to 12,000 sheets, preferably 3000 to 9000 sheets per hour. The printed film is also removable from the stack in the subsequent punching process.

The film may be used particularly advantageously as an in-mould label, in-mould labelling being the preferred method in the injection moulding process.

The invention further relates to a process for producing the inventive polyolefin film according to the coextrusion process that is known on its own merits. In this process, the molten masses corresponding to the individual layers of the film are coextruded simultaneously and together through a flat nozzle, the film obtained in this manner is drawn off on one or more rollers to allow it to solidify, the multilayer film is then stretched (oriented), the stretched film is thermally fixed and if applicable the surface layer thereof is subjected to plasma, corona or flame treatment.

Biaxial stretching (orienting) is performed sequentially or simultaneously. Sequential stretching usually takes place in direct succession, wherein sequential biaxial stretching in which stretching is first performed longitudinally (in the machine direction) and then transversely (perpendicular to the machine direction) is preferred. In the following, the film production process will be described using the example of flat film extrusion with subsequent sequential stretching.

As is usual in extrusion processes, in a first step the polymer or polymer mixture of the individual layers is compressed and liquefied in an extruder, wherein any optional additives may have already been included in the polymer or polymer mixture. The molten masses are then forced simultaneously through a flat nozzle (flat sheet die), and the multilayer film that emerges is drawn off on one or more take-off rollers at a temperature from 10 to 100° C., preferably 10 to 50° C. so that it cools and solidifies.

The film obtained in this way is then stretched longitudinally and transversely to the extrusion direction, which orients the molecule chains. Lengthwise stretching is preferably carried out at a temperature from 70 to 130° C., preferably 80 to 110° C., expediently using two rollers running at different speeds corresponding to the desired stretching ratio, and transverse stretching is carried out preferably at a temperature from 120 to 180° C. with an appropriate tenter. The longitudinal stretching ratios are in the range from 3 to 8, preferably 4 to 6. The transverse stretching ratios are in a range from 5 to 10, preferably 7 to 9.

The film stretching process is followed by thermal fixing (heat treatment), wherein the film is maintained at a temperature of 100 to 160° C. for about 0.1 to 10s. The foil is then rolled up in the normal way with a takeup mechanism.

After biaxial stretching, one or both of the film surfaces is/are preferably subjected to one of the known corona, plasma or flame treatment methods. The treatment intensity is generally in the range from 35 to 50 mN/m, preferably 37 to 45 mN/m.

With corona treatment, the process is advantageously carried out in such manner that the film is fed between two conducting elements serving as electrodes, and a voltage, usually AC voltage (about 5 to 20 kV and 5 to 30 kHz), is applied between the electrodes, the voltage being high enough to cause corona discharges. As a result of these corona discharges the air above the film surface becomes ionised and reacts with the molecules on the film surface, creating polar deposits in the essentially nonpolar polymer matrix.

The surface treatment such as corona treatment may be carried out either immediately during production of the label film or later, for example immediately before the labelling process.

The following measuring methods were used to characterize the raw materials and films:

### Melt Flow Index

The melt flow index of the propylene polymers was measured in accordance with DIN 53 735 under a load of 2.16 kg and at 230° C., and at 190° C. with a load of 2.16 kg for polyethylenes.

### Melting Points

DSC measurement, melt curve maxima, heating rate 20 K/min.

### Density

Density is determined in accordance with DIN 53 479, method A.

### Roughness Measurement

To serve as the roughness measurement, roughness values Rz of the films were measured in the profile method using a type S8P Perthometer manufactured by Feinprüf Perthen GmbH, Göttingen on the basis of DIN 4768 Part 1 and DIN ISO 4288 as well as DIN 4772 and 4774. The measuring head, a single skid scanning system as defined in DIN 4772, was equipped with a scanning tip having a radius of 5 μm and a flank angle of 90° with a contact pressure of 0.8 to 1.12 mN and a skid with a radius of 25 mm in the sliding direction. The vertical measurement range was set to 62.5 μm, the scan section to 5.6 mm, and the RC filter cut-off in accordance with DIN 4768/1 was set to 0.25 mm. All Rz values in the present application refer to this cut off of 0.25 mm.

### Bending Stiffness

Bending stiffness characterizes the resistance of a test piece to bending. Bending stiffness is measured in accordance with DIN 53350.

### Isotaxy

Isotaxy was determined using 13C-NMR on the n-heptane insoluble fraction of the film according to the triad method. This method is described in detail in EP 0645426A1 (pages 9-12).

The invention will now be explained further using the following examples.

### EXAMPLE 1

After the co-extrusion process, a five-layer prefilm was extruded through a flat sheet die. This prefilm was drawn off and solidified on a cooling roller, then oriented longitudinally and transversely, and finally heat-set. The surface of the outer cover layer was pretreated in, a corona process to increase the surface tension. The five-layer film had a layer organisation consisting of a first (outer) cover layer/first intermediate layer/base layer/second intermediate layer/second (inner) cover layer.

The composition of the individual layers of the film was as follows:

First/outer cover layer (1.0 μm):

˜80% by weight ethylene-propylene copolymerisate with an ethylene fraction of 4% by weight and a melting point of 135° C.; melt flow index of 7.3 g/10 min at 230° C. and load of 2.16 kg (DIN 53 735).
˜20% by weight MDPE with an MFI of 0.28 g/10 min (2.16 kg and 190° C.); density of 0.937 g/ccm³ and a melting point of 126° C.
0.1% by weight SiO₂ antiblocking agent
First intermediate layer (7 μm)
100% by weight Propylene homopolymerisate (PP) having a decalin soluble fraction of 1.8% by weight (relative to 100% PP) and a melting point of 166° C.; a melt flow index of 3.2 g/10 min at 230° C. and under load of 2.16 kg (DIN 53 735), and a ¹³C-NMR isotaxy of 98.2%

### Base Layer

85.8% by weight Propylene homopolymerisate (PP) having a decalin soluble fraction of 1.8% by weight (relative to 100% PP), a melting point of 166° C.; a melt flow index of 3.2 g/10 min at 230° C. and under load of 2.16 kg (DIN 53 735), and a ¹³C-NMR isotaxy of 98.2%, and
10% by weight Calcium carbonate with average particle diameter of 3.5 μm
4% by weight TiO2 with average particle diameter of 0.1 to 0.3 μm
0.2% by weight Tertiary aliphatic amine as antistatic agent (Armostat 300)
Second intermediate layer (3.6 μm)
100% by weight Propylene homopolymerisate (PP) having a decalin soluble fraction of 1.8% by weight (relative to 100% PP) and a melting point of 166° C.; a melt flow index of 3.2 g/10 min at 230° C. and under load of 2.16 kg (DIN 53 735), and a ¹³C-NMR isotaxy of 98.2%
Second/inner cover layer (3.0 μm):
˜65% by weight ethylene-propylene copolymerisate with an ethylene fraction of 4% by weight (relative to the copolymer) and a melting point of 135° C.; and a melt flow index of 7.3 g/10 min at 230° C. and a load of 2.16 kg (DIN 53 735).
35% by weight MDPE with an MFI of 0.28 g/10 min (2.16 kg and 190° C.); density of 0.937 g/ccm³ and a melting point of 126° C.
0.1% by weight SiO₂ antiblocking agent

All layers of the film also contained stabilising and neutralising agents in the usual quantities.

In detail, the following conditions and temperatures were selected for production of the film:

Extrusion: Extrusion temperature approx. 250° C.
Cooling roller: Temperature 25° C.,
Longitudinal stretching: T=120° C.
Longitudinal stretching by Factor 4.8
Transverse stretching: T=155° C.
Transverse stretching by Factor 8

### Heat-setting: T=133° C.

The surface of the outer cover layer of the film underwent corona surface treatment. The foil had a thickness of 65 μm. Its roughness Rz on the surface of the first cover layer was 1,4 μm and on the surface of the second cover layer 4.2 μm.

### EXAMPLE 2

A film was produced as described in example 1. In contrast to example 1, the thickness of the outer cover layer was increased to 2.5 μm. In order to maintain the overall thickness of the film, the thickness of the base layer was reduced by about 1.5 μm at the same time. The rest of the composition and the process conditions for producing the film were unchanged. The film had a thickness of 65 μm. The roughness Rz on the surface of the first cover layer increased slightly to 2.0 μm and remained unchanged at 4.2 μm on the surface of the second cover layer.

### EXAMPLE 3

A film was produced as described in example 1. In contrast to example 1, 3.0% by weight TiO₂ was added to both intermediate layers and the propylene-homopolymer fraction was reduced correspondingly to 97% by weight. The rest of the composition and the process conditions for producing the film were unchanged. The film had a thickness of 65 μm. The roughness Rz on the surface of the first cover layer increased to 2.5 μm and was 5.4 μm on the surface of the second cover layer.

### Comparison Example 1

A film was produced as described in example 1. In contrast to example 1, the MDPE fraction was reduced to 0% and the fraction of copolymer was increased to about 100% by weight in both cover layers. The rest of the composition and the process conditions for producing the film were unchanged. The film had a thickness of 65 μm. The roughness Rz on the surface of the first cover layer was 0.6 μm and was 1.0 μm on the surface of the second cover layer.

### Comparison Example 2

A film was produced as described in example 1. In contrast to example 1, the MDPE fraction was reduced to 0% and the fraction of copolymer was increased to about 100% by weight in the outer cover layers. The rest of the composition and the process conditions for producing the film were unchanged. The film had a thickness of 65 μm. The roughness Rz on the surface of the first cover layer was 0.6 μm and remained unchanged at 4.2 μm on the surface of the second cover layer.

### Comparison Example 3

A film was produced as described in example 2. In contrast to example 2, the MDPE fraction was increased to 35% by weight and the fraction of copolymer was reduced to about 65% by weight in the outer cover layers. The rest of the composition and the process conditions for producing the film were unchanged. The film had a thickness of 65 μm. The roughness Rz on the surface of the first cover layer was 3.5 μm and remained unchanged at 4.2 μm on the surface of the second cover layer.

### Comparison Example 4

A film was produced as described in example 2. In contrast to example 2, the MDPE fraction was reduced to 20% by weight and the fraction of copolymer was increased to about 80% by weight in the inner cover layer. Additionally, the composition of the two intermediate layers was changed. Both intermediate layers were now of the same composition as the base layer of example 1. Accordingly, de facto a three-layer film was produced. The rest of the composition and process conditions for producing the film were unchanged. The film had a thickness of 65 μm. The roughness Rz on the surface of the first cover layer was 4.1 μm and was 7.4 μm on the surface of the second cover layer.

### Comparison Example 5

A film was produced as described in comparison example 2. In contrast to comparison example 2, 3% by weight TiO₂ was added to both intermediate layers and the propylene homopolymer fraction was reduced correspondingly. The rest of the composition and process conditions for producing the film were unchanged. The film had a thickness of 65 μm. The roughness Rz on the surface of the first cover layer increased to 1.5 μm and was 5.4 μm on the surface of the second cover layer.

The bending stiffnesses of the films prepared in the examples and comparison examples were compared. A print was then applied to the outer cover layer of each of the films, which were cut to size and stacked. The label stacks prepared in this way were fed to in injection moulding machine by a device for in-mould labelling and used as in-mould labels. The results of these experiments are summarised in the following table:

| | Bending | Print | |
|---|---|---|---|
| | stiffness | image | Destacking |
| Example 1 | +++ | ++ | +++ |
| Example 2 | +++ | ++ | +++ |
| Example 3 | +++ | +* | +++ |
| Comparison example 1 | +++ | +++ | −−− |
| Comparison example 2 | +++ | +++ | −−− |
| Comparison example 3 | +++ | − | +++ |
| Comparison example 4 | −−− | −− | −− |
| Comparison example 5 | +++ | ++ | − |

*the print image was characterized by particularly good whiteness

1-13. (canceled)

14. A multilayered, opaque, biaxially oriented polyolefin film having a thickness of at least 30 μm consisting essentially of a vacuole-containing base layer and intermediate layers applied to both sides thereof, and cover layers applied to either side of the intermediate layers, wherein both intermediate layers have a thickness of at least 3 μM and contain at least 70% by weight of a propylene homopolymer, and both cover layers are constructed from a mixture of incompatible polymers, and the inner cover layer has a surface roughness Rz of at least 3.0 μm (cut off 0.25 mm) and the outer cover layer has a roughness from 1 to 3 μm (cut off 0.25 mm), wherein the roughness of the inner cover layer is at least 1.5 μm greater than the roughness of the outer cover layer.

15. The film as recited in claim 14, wherein both cover layers are constructed from a mixture of propylene homopolymer, propylene copolymer and/or propylene terpolymer and a polyethylene.

16. The film as recited in claim 14, wherein the inner cover layer contains 30 to 90% by weight propylene homopolymer, propylene copolymer and/or propylene terpolymer relative to the weight of the inner cover layer.

17. The film as recited in claim 14, wherein the inner cover layer contains 10 to 70% by weight polyethylene relative to the weight of the inner cover layer.

18. The film as recited in claim 14, wherein the inner cover layer contains 10 to 70% by weight HDPE or MDPE relative to the weight of the inner cover layer.

19. The film as recited in claim 14, wherein the outer cover layer contains 75 to 97% by weight propylene homopolymer, propylene copolymer and/or propylene terpolymer and 3 to 25% by weight polyethylene relative to the weight of the outer cover layer.

20. The film as recited in claim 14, wherein the outer cover layer contains 75 to 97% by weight propylene homopolymer, propylene copolymer and/or propylene terpolymer and 3 to 25% by weight HDPE or MDPE relative to the weight of the outer cover layer.

21. The film as recited in claim 14, wherein each cover layer contains <1% by weight particulate filler materials.

22. The film as recited in claim 14, wherein each cover layer contains <1% by weight of an antiblocking agent.

23. The film as recited in claim 14, wherein the propylene homopolymer of the intermediate layers contains 0 to 2% by weight ethylene in each case.

24. The film as recited in claim 14, wherein one or both intermediate layer(s) contain(s) highly isotactic propylene homopolymer.

25. The film as recited in claim 14, wherein one or both intermediate layer(s) contain(s) TiO₂.

26. The film as recited in claim 14, wherein one or both intermediate layer(s) contain highly isotactic propylene homopolymer having a 13-C-NMR isotaxy (triad) of 96-99%.

27. The film as recited in claim 14, wherein the thickness of each intermediate layer is between 5 to 10 μm.

28. The film as recited in claim 14, wherein both intermediate layers have a density of ≧0.9 g/cm³.

29. An in-mould label which comprises the film as recited in claim 14.

30. An in-mould label process which comprises utilizing the film as recited in claim 14
